(19) United States
(12) Patent Application Publication
(10) Pub. No.: US 2011/0170302 A1
(43) Pub. Date: Jul. 14, 2011

(54) ILLUMINATION APPARATUS WITH A HEAT SINK

(75) Inventors: Nicole Breidenassel, Regensburg (DE); Markus Hofmann, Bad Abbach (DE)

(73) Assignee: OSRAM GESELLSCHAFT MIT BESCHRAENKTER HAFTUNG, Muenchen (DE)

(21) Appl. No.: 13/119,754

(22) PCT Filed: Aug. 28, 2009
(86) PCT No.: PCT/EP2009/061114

§ 371 Date: Mar. 18, 2011

(30) Foreign Application Priority Data
Sep. 19, 2008 (DE) 10 2008 047 934.9

(51) Int. Cl. F21V 29/00

(52) U.S. Cl. 362/373

(57) ABSTRACT

An illumination apparatus is provided. The illumination apparatus may include at least one light-emitting diode; and at least one heat sink for cooling the light-emitting diode, wherein at least one component of the illumination apparatus provided for thermal discharge has an emission coefficient of more than 0.75.

### TECHNICAL FIELD

The invention relates to an illumination apparatus having at least one light-emitting diode (LED) and at least one heat sink for cooling the light-emitting diode.

### PRIOR ART

Illumination apparatuses having light-emitting diodes are increasingly used for general illumination due to the high level of efficiency and reduced production costs. Generally, in this case the light-emitting diodes are operatively connected thermally to a heat sink in order to be able to discharge the heat produced during their operation.

LED lamps represent a particular form of illumination apparatus which are LED-based illumination apparatus, and which are subject to spatial restrictions and thus are preferably designed in one piece. LED lamps are generally used to replace existing conventional lamps, such as for example incandescent lamps or fluorescent lamps, without having to undertake alterations to the light or the lampholder. In LED lamps, therefore, a conventional cap is generally provided for connecting to the mains voltage, usually a further electrical circuit being integrated for converting the mains voltage to the supply voltage of the LED.

Such so-called retrofit lamps are preferably intended to be reminiscent of known incandescent lamps in appearance and, therefore, generally still have a bulb which encloses the support element and the light-emitting diodes, and in its shape is similar to designs known from conventional incandescent lamps. If reflector lamps are to be replaced, the light-permeable element may also just consist of a cover panel which covers the reflector at the light outlet surface.

A drawback with illumination apparatuses according to the prior art, however, and in this case, in particular, in LED lamps is that the heat produced during the operation of the LED is only able to be dissipated inadequately. Although it is possible, by means of various measures, to transmit the heat of the LED effectively to the heat sink, this heat has to be discharged from the heat sink to the surroundings. At the same time, the heat sink is designed to be as compact as possible in order to be able to produce small and thus unobtrusive illumination apparatuses. This is necessary in particular with retrofit LED lamps, as said lamps are not intended to be larger than conventional incandescent lamps in their external dimensions.

### DESCRIPTION OF THE INVENTION

The object of the present invention is, therefore, to provide an illumination apparatus having at least one light-emitting diode (LED) and at least one heat sink for cooling the light-emitting diode, in which the cooling is optimized, so that a smaller heat sink is used and/or the thermal load of the LED is reduced and thus the life and efficiency thereof are increased.

This object is achieved by the characterizing features of claim 1.

Particularly advantageous embodiments are set forth in the dependent claims.

As at least one component of the illumination apparatus provided for heat dissipation, particularly the heat sink, has an emission coefficient of more than 0.75, preferably of more than 0.8, particularly preferably of more than 0.9 at least in sub-regions on at least one free surface, the discharge of radiant heat by these components, i.e. for example by the heat sink, to the surroundings is improved so that with the same surface more heat may be discharged to the surroundings and/or with the same heat output the surface of the component may be reduced.

As only sub-regions of the surface of a component are coated, it is also possible to control the heat output, i.e. for example at locations where a high level of heat output is not desired in order to reduce the heating of adjacent components, or in order to set a specific temperature distribution in the component to be cooled, to discharge less heat than at other points.

Advantageously attempts have frequently been made, in particular with a heat sink, to set an emission coefficient according to the invention for a large proportion or even the entire surface of the component to be cooled.

In an advantageous embodiment of the invention, at least one component of the illumination apparatus is provided at least partially with a coating which has an emission coefficient of more than 0.75, preferably of more than 0.8, particularly preferably of more than 0.9. Coatings are extremely well suited to setting the desired emission coefficient, as they may be applied even to complicated shapes by relatively simple means, and a wide range of properties may be set. Even partial coatings may be produced easily.

In a further advantageous embodiment of the invention at least one component of the illumination apparatus, which has at least partially a surface structure which has an emission coefficient of more than 0.75, preferably of more than 0.8, particularly preferably of more than 0.9. As a result, a particularly simple increase in emissivity is possible, at the same time an ideal connection being achieved to the regions of the component located underneath.

As the illumination apparatus has at least one light-permeable element for protecting the light-emitting diode, in particular a cover panel and/or a bulb, the light-emitting diode is protected from environmental influences, and at the same time advantageous radiation behavior of the illumination apparatus may be achieved by, for example, the light-permeable element being configured as an optical element, in particular as a diffuser or lens. By covering the light-emitting diode, however, the thermal output is hampered, which is why the invention is particularly advantageously effective in illumination apparatuses with a light-permeable element.

The invention is particularly advantageously effective if the illumination apparatus includes at least one cap and thus is suitable as an LED lamp even for retrofit use. In these lamps the light-emitting diodes are generally surrounded by a cap and/or bulb, whereby the output of heat is hampered. As retrofit solutions, such lamps are substantially bound by the shape of conventional lamps, i.e. in particular, the outer contour of the bulb and of the heat sink of the LED lamp correspond to the shape of the bulb of a conventional general-use incandescent lamp, whereby the design of a heat sink, for example, is subjected to narrow restrictions and, in particular, the size thereof is limited. Compared with the prior art, as a result of the design according to the invention a simpler and more effective discharge of heat from the illumination apparatus may be implemented with the same size of heat sink.

As the surface of the light-permeable element has at least partially an emission coefficient of more than 0.75, preferably of more than 0.8, particularly preferably of more than 0.9, the light-permeable element may also be used for discharging heat.

It is also advantageous if adjacent regions of the light-permeable element and the heat sink are of the same color. As a result, the transition from the heat sink to the light-permeable element, at least in the switched-off state of the illumination apparatus, is not clearly visible which is advantageous, in particular, if in a retrofit lamp the impression of a conventional lamp is intended to be conveyed, especially if the heat sink is arranged in a region in which the bulb is located in a conventional lamp, for example an incandescent lamp.

As the color of the heat sink and/or of the light-permeable element is white, even here the impression that it is a conventional lamp, for example an incandescent or fluorescent lamp, is intensified for the user, as in this type of lamp white coloring is also predominant. As a result of the white coloring of the light-permeable element, additionally a diffusion effect is achieved which may be advantageous with LEDs which are likely to be punctiform. Furthermore, this may promote the mixing of colors when using different colored LEDs. A white-coated heat sink will additionally reflect a large proportion of the light falling thereon, this taking place in the white light color which is desirable for general illumination. As a result, the efficiency of the illumination apparatus is markedly increased depending on the arrangement of the LED in relation to the heat sink.

It is particularly advantageous if the coating is able to be applied by means of a powder coating method, as it is a simple and cost-effective method, in order to apply a durable coating which adheres well.

In a further embodiment of the invention, it is advantageous if the coating is able to be applied by means of electroplating methods. Electroplating methods also permit simple manufacturing even for large quantities and produce durable coatings which adhere well.

Expediently, the coating is made from a polymer material. Polymer materials generally have good emission coefficients, may be produced in many different colors and are mostly corrosion resistant and electrically insulating, so that the illumination apparatus may also be used in unfavorable environmental conditions.

Expediently, the coating is configured as paint. Paints are liquid or powdered coating materials which are thinly applied onto objects, and in which a permanent, solid film is formed by chemical or physical processes (for example vaporization of solvents or the reaction of components with one another). Paints may be easily applied and are available in a wide range, for example as 1-component or 2-component paints, frequently in the form of oil-based paint or plastic-based paint, so that the properties may be selected according to use.

It is advantageous if the heat sink is at least partially made from a metal material having high thermal conductivity, in particular an alloy based on aluminum and/or copper and/or magnesium. As a result, heat is dissipated from the LED in a very efficient manner.

In a further advantageous embodiment, the heat sink is made at least partially from a ceramic material. Ceramic materials are electrically insulating, so that an insulating layer is not required between the LED and heat sink. Additionally, said materials are very resistant to many environmental influences, such as for example corrosion or high temperatures, which in particular facilitates the coating. In particular, aluminum nitride is suitable as the material for the heat sink due to the high thermal conductivity, but also the use of aluminum oxide, zirconium oxide, silicon carbide or silicon nitride and CFC materials is conceivable.

It is advantageous if the light-permeable element is made from glass, as this provides a good combination of light permeability, resistance to environmental influences, in particular UV radiation, and good emissivity.

Naturally, further advantageous embodiments are conceivable. The light-permeable element may be both transparent and opaque depending on requirements, different coloring of the light-permeable element also being conceivable in order, for example, to alter the color of the radiated light or to alter the impression of the illumination apparatus in the switched-off state.

It may also be advantageous if the light-permeable element is made from a polymer material, as these materials are simple and cost-effective to produce and handle, and available both as transparent and opaque, the latter being advantageous, in particular, if the light-permeable element is intended to act as a diffuser.

It may also be advantageous if the light-permeable element and the heat sink have a different color as this, for example, illustrates to the user the boundary between a component (heat sink) which is likely to be heated up during operation and a relatively cool component in comparison (light-permeable element, for example the bulb) and thus the user is reliably able to avoid contact with the hot component.

For the type of surface structure or the coating, a plurality of variants is also known to the person skilled in the art, as are the respective techniques required for production. Thus the surface of a metal heat sink may advantageously be modified by means of electroplating methods such as oxidation or anodizing, coloring also being possible. Furthermore different painting methods such as spray painting or dip coating, thermal spraying methods, enameling, sputtering or deposition from the gas phase are naturally possible. The material may in this case be a paint, for example a conventional radiator paint, but also other materials, such as for example ceramics, are conceivable. In many cases, a thin coating made of a synthetic material may also be suitable to fulfill requirements.

### BRIEF DESCRIPTION OF THE DRAWINGS

The invention is to be described in more detail with reference to exemplary embodiments. In the figures:

FIG. 1 shows an LED lamp as an example of an illumination apparatus according to the invention,

FIG. 2 shows a further LED lamp as an example of an illumination apparatus according to the invention.

### PREFERRED EMBODIMENT OF THE INVENTION

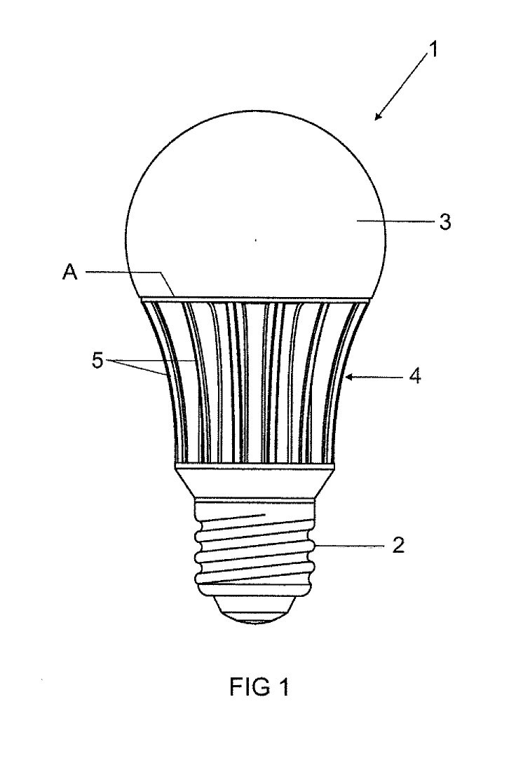

FIG. 1 shows an LED lamp 1 including a cap 2, a bulb 3 as the light-permeable element 3 and a heat sink 4 as an example of an illumination apparatus 1 according to the invention. The light-emitting diodes are not shown here, as they are arranged inside the opaque bulb 3 on the upper face A of the heat sink 4. A wide range of suitable light-emitting diodes having different performance classes and colors are known to the person skilled in the art. Also not shown are the electronic components required for the voltage supply of the light-emitting diodes, which may be arranged in the cap or in the region of the heat sink 4. Also, the design of these components and the integration in an LED lamp are known in principle to the person skilled in the art.

The LED lamp 1 is provided as a retrofit solution for a conventional general-use incandescent lamp comprising an E27 screw cap, so that the cap 2 is also designed as an E27 screw cap 2, and the assembly consisting of the bulb 3 and the heat sink 4 corresponds in its shape substantially to the bulb of a general-use incandescent lamp.

The heat sink 4 in the present exemplary embodiment is made from aluminum, has numerous cooling fins 5 for enlarging the surface and is provided with a white spray paint made of a commercially available radiator paint, the emission coefficient thereof being approximately 0.91-0.95. Such paints are available in a wide range and in different colors, for example under the trade name, “Belton special radiator paint”. As the bulb 3 of the LED lamp 1 consists of an opaque, white synthetic material, a uniform appearance is achieved, which for the user, in particular even when the LED lamp 1 is not in operation, does not differ substantially from that of a conventional frosted incandescent lamp or a compact fluorescent lamp with a tube.

The paint considerably increases the emission coefficient, which for polished aluminum typically has a value of less than 0.1 and, when roughened, a maximum value of 0.3-0.4. Thus the cooling efficiency with passive cooling and power densities of 1 to 8 W/cm³, as is common in LED heat sinks, is improved by up to 30%.

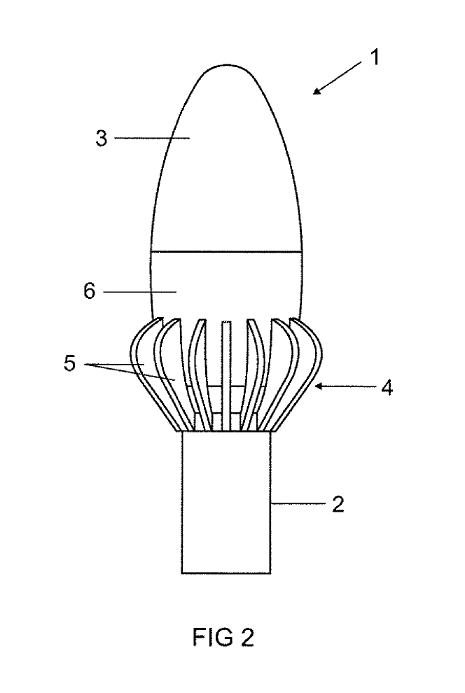

A further embodiment of the invention is shown in FIG. 2. A retrofit LED lamp 1 is also shown here again, in this exemplary embodiment a cap of the type B15d having been used and the bulb 3 having the shape of a candle. In contrast to the previous exemplary embodiment, the bulb 3 is made from glass and in its lower region 6 is provided with a coating according to the invention with an emissivity of 0.95. As a result, in the region 6 of the bulb 3 which is surrounded by the cooling fins 5 of the heat sink 4 and is heated as a result, the heat output relative to the uncoated bulb 3 is substantially improved. The coating has been applied to the bulb 3 and to the heat sink 4 by means of powder coating. As a result of the coating the user is able to identify which region of the LED lamp 1 is expected to be at a higher temperature, so that the user is reliably able to avoid contact with this region. In the present exemplary embodiment, the coating is silver-colored, in order to clarify for the user the cooling area.

Naturally, still further embodiments of the invention are conceivable, in particular the design of the illumination apparatus may differ considerably from the embodiments shown. Thus, for example, retrofit LED lamps are conceivable, which have the shape of conventional reflector lamps and in which the heat sink has the shape of the reflector of the conventional lamp. The light-permeable element is in this case designed as an approximately planar cover panel. Also, embodiments are conceivable in which the illumination apparatus does not have the shape of an LED retrofit lamp and the heat sink is also not arranged in the immediate vicinity of the LEDs, but is operatively connected thereto only thermally, for example via a heat pipe.

The coloring of the coating according to the invention may also be undertaken according to the requirements of the illumination apparatus. Thus, in particular, in colored light-permeable elements a color of the coating which is as close a match as possible, or a contrasting effect, may be desirable. An identification of the heated regions by a color with a signaling effect which is associated with heat by the user, in particular red, is also conceivable as an advantageous embodiment.

1. An illumination apparatus, comprising:
at least one light-emitting diode; and
at least one heat sink for cooling the light-emitting diode,
wherein at least one component of the illumination apparatus provided for thermal discharge has an emission coefficient of more than 0.75.

2. The illumination apparatus as claimed in claim 1, wherein at least one component of the illumination apparatus is provided at least partially with a coating which has an emission coefficient of more than 0.75.

3. The illumination apparatus as claimed in claim 1,
wherein at least one component of the illumination apparatus has at least partially a surface structure which has an emission coefficient of more than 0,75.

4. The illumination apparatus as claimed in claim 1,
wherein the illumination apparatus has at least one light-permeable element for protecting the light-emitting diode.

5. The illumination apparatus as claimed in claim 1,
wherein the illumination apparatus comprises at least one cap.

6. The illumination apparatus as claimed in claim 4,
wherein the surface of the light-permeable element has at least partially an emission coefficient of more than 0.75.

7. The illumination apparatus as claimed in claim 1,
wherein adjacent regions of the light-permeable element and the heat sink are of the same color.

8. The illumination apparatus as claimed in claim 1,
wherein the color of at least one of the heat sink and of the light-permeable element is white.

9. The illumination apparatus as claimed in claim 2,
wherein the coating is configured to be applied by means of a powder coating method.

10. The illumination apparatus as claimed in claim 2,
wherein the coating is configured to be applied by means of an electroplating method.

11. The illumination apparatus as claimed in claim 2,
wherein the coating is made from a polymer material.

12. The illumination apparatus as claimed in claim 2,
wherein the coating is configured as paint.

13. The illumination apparatus as claimed in claim 1,
wherein the heat sink is made at least partially from a metal material having high thermal conductivity.

14. The illumination apparatus as claimed in claim 1,
wherein the heat sink is made at least partially from a ceramic material.

15. The illumination apparatus as claimed in claim 4,
wherein the light-permeable element is made from glass.

16. The illumination apparatus as claimed in claim 1,
wherein the heat sink has an emission coefficient of more than 0.75 at least in sub-regions on at least one free surface.

17. The illumination apparatus as claimed in claim 16,
wherein the at least one component of the illumination apparatus provided for thermal discharge has an emission coefficient of more than 0.8 at least in sub-regions on at least one free surface.

18. The illumination apparatus as claimed in claim 17,
wherein the at least one component of the illumination apparatus provided for thermal discharge has an emission coefficient of more than 0.9 at least in sub-regions on at least one free surface.

19. The illumination apparatus as claimed in claim 2,
wherein the coating has an emission coefficient of more than 0.8.

20. The illumination apparatus as claimed in claim 3,
wherein the surface structure has an emission coefficient of more than 0.8.
